(19) United States
(12) Patent Application Publication
(10) Pub. No.: US 2009/0095208 A1
(43) Pub. Date: Apr. 16, 2009

(54) Water drift compensation method and device

(76) Inventors: Miguel Angel Cardoza, Round Rock, TX (US); William Andrew Adamez, Round Rock, TX (US); Devin Morgan Tomlinson, Pflugerville, TX (US); Sarah Ann Benedict, Austin, TX (US); Mark Henry Wolf, Fort Wayne, IN (US)

Correspondence Address: Miguel Angel Cardoza, 1703 Woodvista Place, Round Rock, TX, 78665, US

(21) Appl. No.: 12/151,397

(22) Filed: May 6, 2008

Related U.S. Application Data
(60) Provisional application No. 60/917,432, filed on May 11, 2007.

(51) Int. Cl. B63H 25/42; G05D 1/02; G01C 21/00; B43L 9/02

(52) U.S. Cl. 114/144 B; 114/144 R; 701/213; 701/220; 33/27.02; 701/200

(57) ABSTRACT

Current methods for station keeping an object in the ocean or body of water involve mooring assemblies or active and complex navigation and differential thrust or thrust and rudder assemblies. The embodiments herein provide a method and device for compensating for the force of water or ocean currents through the use of a hydrofoil assembly to orient a device in the water current direction, through the use of any number of devices for sensing water current force, and through the use of a motor assembly to produce sufficient thrust to compensate for water current drift. An alternate embodiment allows the method to be employed without sensing the force of the water current. The method does not require directional thrust or active rudder assemblies, is highly portable, utilizes minimal power, is light weight, is scalable, and can be operated in any body of water.

### CROSS-REFERENCE TO RELATED APPLICATIONS

This application claims benefit of PPA Ser. No. 60/917,432, filed May 11, 2007 by the present inventors, which is incorporated by reference.

### FEDERALLY SPONSORED RESEARCH

Not Applicable SEQUENCE LISTING OR PROGRAM

Not Applicable

### BACKGROUND OF THE INVENTION

1. Field of Invention

Embodiments presented herein generally relate to a method or process of compensating for the position or location displacement caused by the force of water or ocean current. More specifically, embodiments relate to a device that compensates for this force by utilizing the force of the water current to orient the means of compensation.

2. Prior Art

The force of an ocean or water current will alter the position or location of an object. The amount of the resulting displacement is a function of the magnitude of the force of the water current and the cross sectional area and coefficient of drag of the object. Previously the means for reducing or compensating for the position or location displacement caused by the force of water current was to rely on mooring systems to anchor objects to fixed locations such as the ocean floor. There are several problems with mooring systems, particularly when utilizing such methods in deep water. Mooring systems engineered for deep water must be of a physical size, weight, and complexity which makes them costly and difficult to deploy. In addition, to be effective, a mooring system must account for changes in the ocean environment, such as tide changes, wave action, ocean currents, and other forces caused by severe weather. Furthermore, long mooring cables lead to large variations in the location of the object being moored. Such displacements are commonly referred to as watch circles. The size of the watch circle is proportional to the depth of the mooring system. For applications where precise object placement is required, large watch circle errors can be problematic. Still further, mooring systems require time to prepare and deploy, and thus are not effective for portable applications.

Efforts have been made to develop methods for compensating for the displacement caused by water current. One such method is exemplified in U.S. Pat. No. 2,941,492 to Wilcoxon. The Wilcoxon patent relates to a self propelled, steerable, and remotely controlled buoy. The exemplified device uses a propeller to pull the device through the water and a rudder assembly to orient the direction of travel. A remote operator controls the motor thrust and rudder direction. The device does not measure the drift of the water current. The device uses significant means of control and power to position or locate the device to a predetermined location.

An additional means to compensate for the displacement caused by water current is exemplified in U.S. Pat. No. 3,369,516 to Pierce. The Pierce patent relates to a two-part buoy system. One part of the device is allowed to move freely on the surface of the water. A second part of the device is fixed on the ocean floor at a predetermined location. The surface portion of the device uses a propulsion and navigation system to maintain position over the portion of the device fixed no the ocean floor. The method employed uses a navigation system which uses an active or passive sonar to determine the distance and location of the surface device relative to the device fixed on the ocean floor. The propulsion system then activates to compensate for displacement relative to this fixed reference location. The device does not measure the drift of the water current. The device is not portable. The device uses significant means of control and power to maintain a fixed position on the surface of the earth.

An additional means to compensate for the force of ocean current is exemplified in U.S. Pat. No. 6,854,406 to Cardoza. The Cardoza patent relates to an autonomous surface watercraft. The watercraft uses a propulsion and navigation system to navigate to or remain at a known location on the surface of the water. The navigation system uses radio frequency signals from the Global Positioning System (GPS) to determine its geodetic location on the surface of the earth. The navigation system uses a compass to determine the vehicle's heading orientation. The watercraft uses differential thrust produced from two propulsion units to orient and move through the water to a predetermined geodetic location. The watercraft device does not use water currents to orient the propulsion units in the proper direction to compensate for water current force and therefore requires significant means for control and power.

An additional means to compensate for the force of ocean current is exemplified in U.S. Pat. No. 5,577,942 to Juselis. The Juselis patent relates to a station keeping buoy. The station keeping buoy uses a propulsion and a navigation system to station keep at a predetermined location. The navigation system uses radio frequency signals from the Global Positioning System (GPS) to determine its geodetic location on the surface of the water. The navigation system uses a compass to determine the heading orientation of the buoy. The buoy uses bi-directional propulsion from two propulsion units to laterally move through the water to a predetermined geodetic location. In another embodiment of the device, the buoy may use compass information to orient the thrust from a single propulsion unit to achieve the same effect. The station keeping buoy device does not use water currents to orient the propulsion unit in the proper direction to compensate for water current force and therefore requires significant means for control and power.

### SUMMARY

In accordance with one embodiment, the present invention provides a means to compensate for the force of water current. The invention uses the flow of the water current over a hydrofoil to orient one or more propulsion units in the direction opposite of the water current force direction. The invention determines the force of the water current by various means and applies sufficient propulsion to compensate for the displacement caused by the water current force.

### DRAWINGS

### Figures

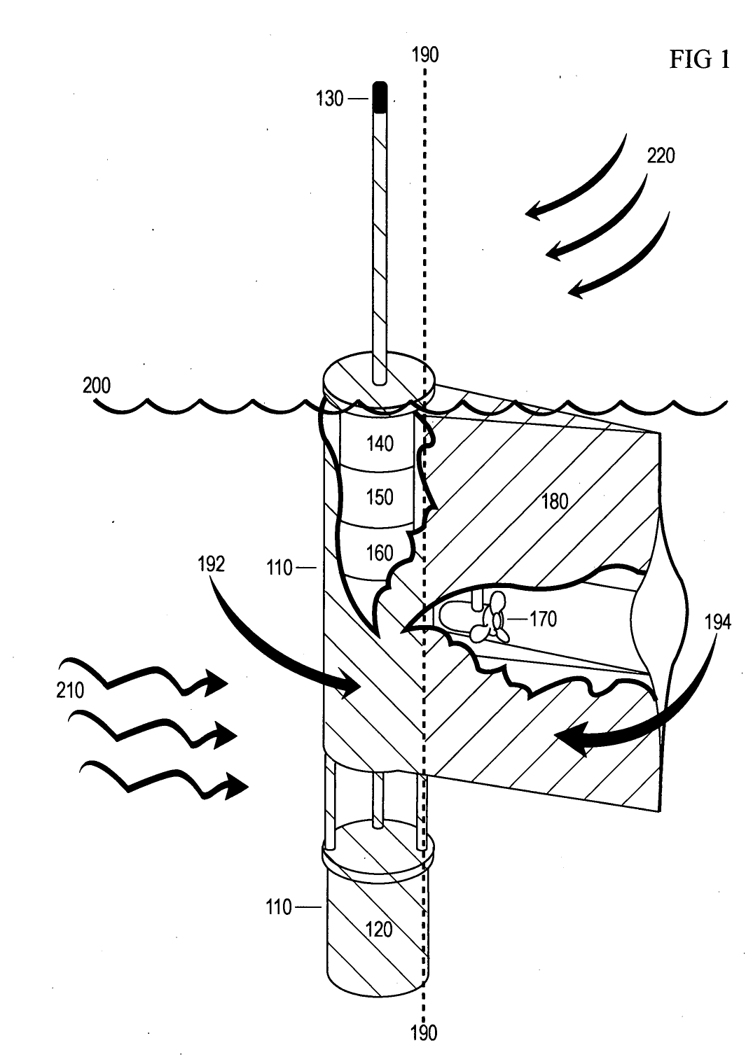

FIG. 1 is a cutaway operational drawing of the invention which utilizes a GPS navigation receiver in accordance with one embodiment.

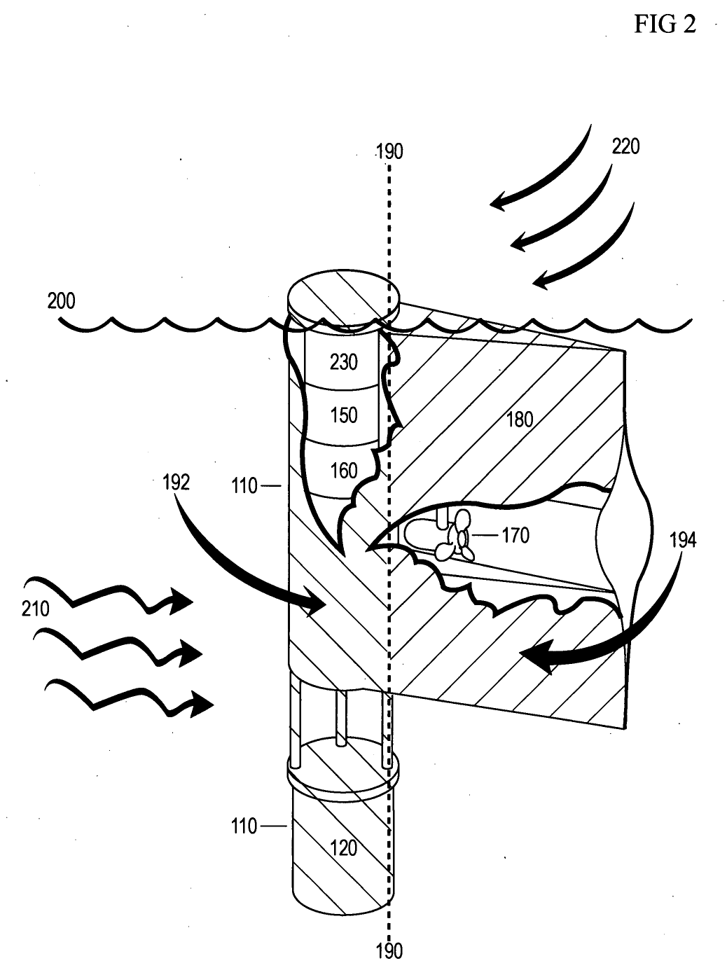

FIG. 2 is a cutaway operational drawing of the invention which utilizes an inertial measurement device in accordance with another embodiment.

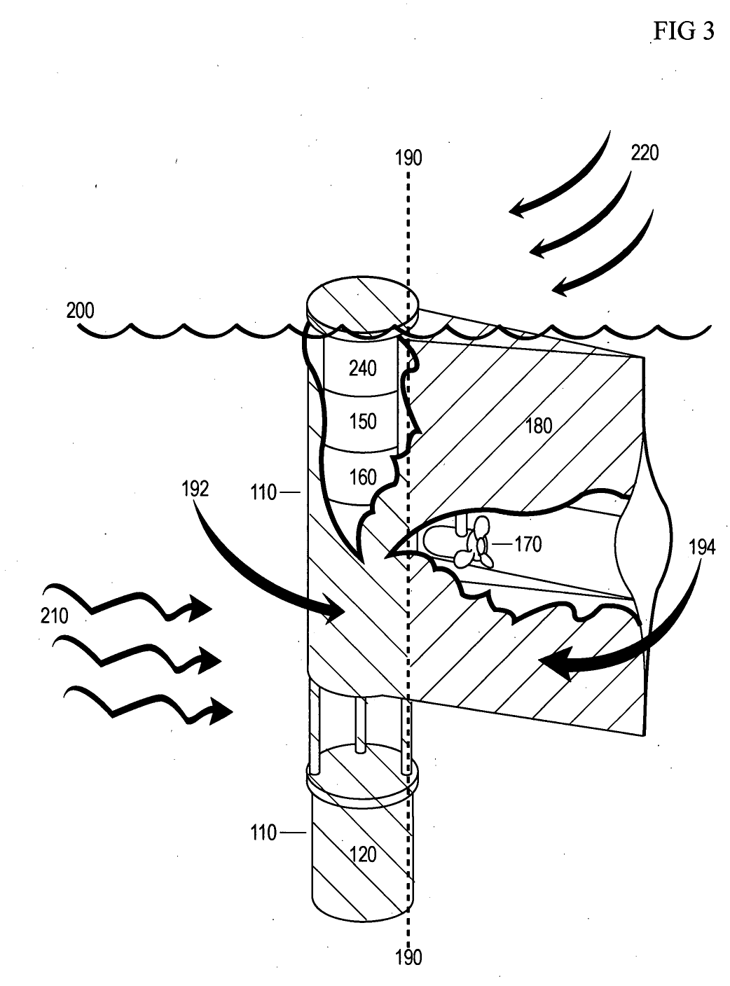

FIG. 3 is a cutaway operational drawing of the invention which utilizes a compass or rotation sensing device in accordance with another embodiment.

### REFERENCE NUMERALS

| | | | |
|---|---|---|---|
| 110 | water-tight enclosure | 120 | battery |
| 130 | GPS antenna | 140 | GPS navigation receiver |
| 150 | computer processor | 160 | motor controller |
| 170 | motor or thruster | 180 | hydrofoil |
| 190 | pivot axis | 192 | small surface area |
| 194 | large surface area | 200 | waterline |
| 210 | water current | 220 | wind current |
| 230 | inertial measurement device | 240 | rotation sensing device or |
| | | | compass |

### DETAILED DESCRIPTION

### First Embodiment—FIG. 1

One embodiment of the device is illustrated in FIG. 1. The device includes a water-tight enclosure 110 for electronics instrumentation and the same or similar water-tight enclosure 110 for a power source, such as one or more batteries 120. The device provides sufficient surface area to install a GPS antenna 130 for receiving the radio frequency signals transmitted by the GPS satellite system. The GPS antenna is connected to a GPS navigation receiver 140 located within the water-tight enclosure.

The GPS navigation receiver is connected to a computer processor 150 located within the water-tight enclosure. The computer processor is connected to a motor controller 160 located within the water-tight enclosure. The motor controller is connected through a water-tight connector to one or more motors, thrusters, or other means of water propulsion 170 located outside the water-tight enclosure. The water-tight enclosure and propulsion system are attached to a hydrofoil 180.

The hydrofoil is designed such that the cross-sectional area on one side of the center of mass is much greater than the other side. This design allows for the device to pivot about a vertical line or pivot axis 190 through the center of mass such that the larger surface area 194 is down current from the smaller surface area 192.

### OPERATION

### First Embodiment—FIG. 1

The device ideally is designed with a level of buoyancy such that most of the device is located below the waterline 200. This allows the device to move principally due to the force of the water current 210 and less with the force of wind current 220, which may be in a direction other than the water current.

In the presence of a water current, the device will rotate about a vertical line or pivot axis 190 that transects through the center of the mass of the device. While I believe the reaction occurs in the same manner as it does with a weather vane, I do not wish to be bound by this. In theory, the reaction occurs as in the case of a weather vane, due to the difference in area in front of and behind the pivot point. In the case of the weather vane, this point is fixed external to the weather vane. The weather vane has a smaller cross-sectional area to one side of the pivot point and a larger cross-sectional area to the opposite side of the pivot point. As the wind current flows across the weather vane it creates a pressure. The pressure times the surface area over which it acts creates a force proportional to the area. The difference in force on the two surface areas causes the larger area with the larger force to be moved down wind of the pivot point from the smaller area. As applied to the embodiment of the invention herein described, the pivot point is the point of rotation through the center of mass of the device 190 and the resulting water current pressure difference will cause the larger surface area 194 to rotate down current from the smaller surface area 192.

The GPS antenna 130 receives radio frequency signals transmitted by the GPS satellite system. This antenna is connected to a GPS navigation receiver 140 located within the water-tight enclosure. The GPS navigation receiver may provide geodetic position and velocity measurements on the device. These position and velocity measurements may be referenced to the World Geodetic Service-1984 (WGS-84) reference ellipsoid, but other reference frames may be used.

The GPS navigation receiver is connected to a computer processor 150. The computer processor uses measurements from the GPS navigation receiver to compute the velocity of the device as it passively moves with the force of the water current. One means for determining the amount of water force or drift speed may include differencing GPS navigation receiver position measurements over a discrete period of time to provide a measure of the drift rate of the device. For example, a GPS receiver may provide geodetic latitude and longitude values periodically in time. By subtracting the latitude and longitude values from the first measurement from the values from a second measurement, and dividing this difference by the elapsed time, a velocity vector in latitude and longitude may be computed. By computing the sum of the squared values of each component a drift speed for the device may be computed.

Similarly, the computer processor may compute the drift speed of the device using instantaneous velocity measurements that may be produced from the GPS navigation receiver. The GPS navigation receiver instantaneous velocity vector may be converted into a single scalar quantity that represents the speed or perceived drift rate of the device by computing the sum of the squared values of each component of the velocity vector. Regardless of the specific technique employed, the computer processor can utilize data from the GPS navigation receiver to determine the drift speed of the device due solely to the force of the water current.

The computer processor is connected to a motor controller 160. The computer processor sends signals to the motor controller for the desired propulsion required from the propulsion system. The motor controller is connected to one or more motors, thrusters, or other means of water propulsion 170. The motor controller sends signals to one or more motors to provide sufficient power to compensate for the force of the current on the device.

Thus, in this embodiment, by using the hydrofoil to orient the device, propulsion can be employed to compensate for the force of the water current without mooring assemblies, ocean floor reference devices, active differential thrust or rudder assemblies, knowledge of the geodetic location of the device, orientation of the device, or a pre-determined position as required in prior-art methods employed.

### DESCRIPTION

### Alternative Embodiment—FIG. 2

An alternate embodiment of the device is illustrated in FIG. 2. The device includes a water-tight enclosure 110 for electronics instrumentation and the same or similar water-tight enclosure 110 for a power source, such as one or more batteries. An inertial measurement device 230 is located within the water-tight enclosure. The inertial measurement device is connected to a computer processor 150 located within the water-tight enclosure. The computer processor is connected to a motor controller 160 located within the water-tight enclosure. The motor controller is connected through a water-tight connector to one or more motors, thrusters, or other means of water propulsion 170 located outside the water-tight enclosure. The water-tight enclosure and propulsion system are attached to a hydrofoil 180.

The hydrofoil is designed such that the cross-sectional area on one side of the center of mass is much greater than the other side. This design allows for the device to pivot about a vertical line or pivot axis 190 through the center of mass such that the larger surface area 194 is down current from the smaller surface area 192.

### Alternate Embodiment—FIG. 2

The device ideally is designed with a level of buoyancy such that most of the device is located below the waterline 200. This allows the device to move principally due to the force of the water current 210 and less with the force of wind current 220, which may be in a direction other than the water current.

In the presence of a water current, the device will rotate about a vertical line or pivot axis 190 that transects through the center of the mass of the device. While I believe the reaction occurs in the same manner as it does with a weather vane, I do not wish to be bound by this. In theory, the reaction occurs as in the case of a weather vane, due to the difference in area in front of and behind the pivot point. In the case of the weather vane, this point is fixed external to the weather vane. The weather vane has a smaller cross-sectional area to one side of the pivot point and a larger cross-sectional area to the opposite side of the pivot point. As the wind current flows across the weather vane it creates a pressure. The pressure times the surface area over which it acts creates a force proportional to the area. The difference in force on the two surface areas causes the larger area with the larger force to be moved down wind of the pivot point from the smaller area. As applied to the embodiment of the invention herein described, the pivot point is the point of rotation through the center of mass of the device 190 and the resulting pressure difference will cause the larger surface area 194 to rotate down current from the smaller surface area 192.

The inertial measurement device 230 may be any device that can directly sense the physical displacement of the object. For example, an accelerometer is an inertial measurement device that measures acceleration of an object in a specific axis of motion. Three accelerometer devices arranged in orthogonal directions form an inertial measurement unit (IMU) capable of providing acceleration values in the three-axis of motion it perceives. The inertial measurement device 230 is connected to a computer processor 150 for processing IMU measurements. The acceleration values from the IMU may be integrated over a discrete period of time to produce a velocity vector for the device in each of the three-axis. This velocity vector can then be converted into a single scalar quantity that represents the speed or perceived drift of the device by computing the sum of the squared values of each component a velocity vector.

The computer processor is connected to a motor controller 160. The computer processor sends signals to the motor controller for the desired propulsion required from the propulsion system. The motor controller is connected to one or more motors, thrusters, or other means of water propulsion 170. The motor controller sends signals to one or more motors to provide sufficient power to compensate for the force of the current on the device.

Thus, in this embodiment, by using the hydrofoil to orient the device, propulsion can be employed to compensate for the force of the water current without mooring assemblies, ocean floor reference devices, active differential thrust or rudder assemblies, knowledge of the geodetic location of the device, orientation of the device, or a pre-determined position as required in prior-art methods employed.

### Alternative Embodiment—FIG. 3

An alternate embodiment of the device is illustrated in FIG. 3. The device includes a water-tight enclosure 110 for electronics instrumentation and the same or similar water-tight enclosure 110 for a power source, such as one or more batteries. A compass or other rotation sensing device 240 is located within the water-tight enclosure. The compass or other rotation sensing device is connected to a computer processor 150 located within the water-tight enclosure. The computer processor is connected to a motor controller 160 located within the water-tight enclosure. The motor controller is connected through a water-tight connector to one or more motors, thrusters, or other means of water propulsion 170 located outside the water-tight enclosure. The water-tight enclosure and propulsion system are attached to a hydrofoil 180.

The hydrofoil is designed such that the cross-sectional area on one side of the center of mass is much greater than the other side. This design allows for the device to pivot about a vertical line or pivot axis 190 through the center of mass such that the larger surface area 194 is down current from the smaller surface area 192.

### Alternate Embodiment—FIG. 3

The device ideally is designed with a level of buoyancy such that most of the device is located below the waterline 200. This allows the device to move principally due to the force of the water current 210 and less with the force of wind current 220, which may be in a direction other than the water current. In this embodiment, there is no need to measure or determine the drift rate or speed of the device in the water current.

In the presence of a water current, the device will rotate about a vertical line or pivot axis 190 that transects through the center of the mass of the device. While I believe the reaction occurs in the same manner as it does with a weather vane, I do not wish to be bound by this. In theory, the reaction occurs as in the case of a weather vane, due to the difference in area in front of and behind the pivot point. In the case of the weather vane, this point is fixed external to the weather vane. The weather vane has a smaller cross-sectional area to one side of the pivot point and a larger cross-sectional area to the opposite side of the pivot point. As the wind current flows across the weather vane it creates a pressure. The pressure times the surface area over which it acts creates a force proportional to the area. The difference in force on the two surface areas causes the larger area with the larger force to be moved down wind of the pivot point from the smaller area. As applied to the embodiment of the invention herein described, the pivot point is the point of rotation through the center of mass of the device 190 and the resulting pressure difference will cause the larger surface area 194 to rotate down current from the smaller surface area 192.

A compass or other rotation sensing device 240 senses the orientation of the device. The compass or other rotation sensing device 240 is connected to a computer processor 150 for processing compass or rotation measurements. The computer processor is connected to a motor controller 160. The computer processor sends signals to the motor controller for a desired level of propulsion required from the propulsion system. The motor controller is connected to one or more motors, thrusters, or other means of water propulsion 170. The motor controller sends signals to one or more motors to provide a desired level of propulsion.

If the amount of propulsive force emitted from the motors is greater than the force of the water current, the device hydrofoil 180 will become unstable and will rotate or change direction in any of the yaw, pitch, or roll axis. Any change in device orientation is sensed by the compass or other rotation sensing device. The resulting signals are processed by the computer processor, which sends a signal to the motor controller to reduce the propulsion of the motors. Similarly, when the propulsion is applied if there is no change in the stability or orientation of the device, as sensed by the compass or other rotation sensing device, the computer processor sends a command to the motor controller to increase the propulsion from the motors. Through this feed-back mechanism an optimal level of propulsion is established to counter the force of the water current on the device.

Thus, in this embodiment, by using the hydrofoil to orient the device, propulsion can be employed to compensate for the force of the water current without mooring assemblies, ocean floor reference devices, active differential thrust or rudder assemblies, knowledge of the geodetic location of the device, orientation of the device, or a pre-determined position as required in prior-art methods employed.

### CONCLUSION, RAMIFICATIONS, AND SCOPE

Accordingly, the reader will see that according to the embodiments of the invention, we have provided a hydrofoil orientation method and multiple device configurations that will compensate for the displacement caused by water or ocean currents. Further, at least one embodiment of the invention, as given in FIG. 3, can be employed with only five components, leading to a more reliable, lower power, lighter weight, smaller, more portable and yet efficient device to compensate for water drift.

While the above description contains many specificities, these should not be construed as limitations on the scope of any embodiment, but as exemplifications of the presently preferred embodiments thereof. Many other ramifications and variations are possible within the teachings of the various embodiments. For example, there are an infinite number of specific shapes and orientations of the hydrofoil that will achieve the same effective result of orientation of the device with the direction of water current flow. Likewise, the method described may be scalable to an infinite number of sizes, from very small hand held devices to very large ocean platforms. Further, the method described may be implemented with any number of propulsion methods or devices, from simple trolling motor type devices to very efficient but costly brushless-motor based thrusters. Still further, the method may be employed by placing the propulsion method in any number of locations and orientations. For example, the propulsion method may be placed in an orientation to pull or push the device through the water. Also, as in the case of the third embodiment described in FIG. 3, the propulsion method may be placed in a location on the device to maximize the instability experienced when the force of propulsion exceeds the force of the water current. In so doing, the device can more easily detect instability and thus set the propulsion force more precisely. Lastly, for the third embodiment of the device, FIG. 3, there are several means for measuring the angular rotation of the device in any of the three-dimensional axis that would provide an indication that the motor setting was sufficiently high as to cause instability. Such devices may include but are not limited to a two-axis tilt sensor, a gyroscope, an inclinometer, or a rotary inductive position sensor.

Thus the scope of the invention should be determined by the appended claims and their legal equivalents, and not by the examples given.

1. A method or process of compensating for the physical displacement caused by the force of ocean or water current by utilizing the force of the ocean current on a hydrofoil device to orient the means of compensation.

2. The method of claim 1 wherein the hydrofoil device comprises a shape that orients the hydrofoil device in a direction uniform to the prevailing ocean or water current.

3. The method of claim 1 wherein the hydrofoil device is principally below the surface of the water to minimize the force of wind loading.

4. The method of claim 1 wherein the hydrofoil device comprises at least one navigation module disposed within the hull assembly, wherein at least one navigation module comprises at least one Global Positioning System receiver.

5. The method of claim 1 wherein the hydrofoil device comprises at least one navigation module disposed within the hull assembly, wherein at least one navigation module comprises at least one inertial measurement device.

6. The method of claim 1 wherein the hydrofoil device comprises at least one navigation module disposed within the hull assembly, wherein at least one navigation module comprises at least one compass device.

7. The method of claim 1 wherein the hydrofoil device comprises at least one navigation module disposed within the hull assembly, wherein at least one navigation module comprises at least one computer processor.

8. The method of claim 1 wherein the hydrofoil device comprises at least one battery.

9. The method of claim 1 wherein the hydrofoil device comprises at least one propulsion device comprising one or more thrusters coupled to the hydrofoil device.

10. The method of claim 7 wherein the one or more thrusters are configured to provide variable thrust.

11. The method of claim 1 wherein the hydrofoil device determines the appropriate level of thrust or force by measuring the water current force using position measurements from the Global Positioning System receiver.

12. The method of claim 1 wherein the hydrofoil device determines the appropriate level of thrust or force by measuring the water current force using velocity measurements from the Global Positioning System receiver.

13. The method of claim 1 wherein the hydrofoil device determines the appropriate level of thrust or force by measuring the water current force using inertial measurements.

14. The method of claim 1 wherein the hydrofoil device determines the appropriate level of thrust or force by sensing the heading orientation of the object using a digital or analog compass.

15. The method of claim 1 wherein the hydrofoil device determines the appropriate level of thrust or force by sensing the heading orientation of the object using a rotational electronic or mechanical sensor.
